(19) United States
(12) Patent Application Publication
(10) Pub. No.: US 2001/0037435 A1
(43) Pub. Date: Nov. 1, 2001

(54) Distributed address mapping and routing table mechanism that supports flexible configuration and partitioning in a modular switch-based, shared-memory multiprocessor computer system

(76) Inventor: Stephen R. Van Doren, Northborough, MA (US)

Correspondence Address: CESARI AND MCKENNA, LLP, 88 BLACK FALCON AVENUE, BOSTON, MA, 02210, US

(21) Appl. No.: 09/814,185

(22) Filed: Mar. 21, 2001

Related U.S. Application Data
(60) Provisional application No. 60/208,288, filed on May 31, 2000.

(51) Int. Cl. G06F 12/00

(52) U.S. Cl. 711/153; 711/209; 711/119

(57) ABSTRACT

A distributed address mapping and routing technique supports flexible configuration and partitioning in a modular, shared memory multiprocessor system having a plurality of multiprocessor building blocks interconnected by a switch fabric. The technique generally employs physical-to-logical address translation mapping in conjunction with source routing. Mapping operations, such as address range or processor identifier operations, used to determine a routing path through the switch fabric for a message issued by a source multiprocessor building block are resolved through the generation of a routing word. That is, each message transmitted by a source multiprocessor building block over the switch fabric has an appended routing word that specifies the routing path of the message through the fabric.

### CROSS-REFERENCE TO RELATED APPLICATIONS

The present application claims priority from U.S. Provisional Patent Application Serial No. 60/208,288, which was filed on May 31, 2000, by Stephen Van Doren for a DISTRIBUTED ADDRESS MAPPING AND ROUTING TABLE MECHANISM THAT SUPPORTS FLEXIBLE CONFIGURATION AND PARTITIONING IN A MODULAR SWITCH-BASED, SHARED-MEMORY MULTIPROCESSOR COMPUTER SYSTEM, which application is hereby incorporated by reference.

### BACKGROUND OF THE INVENTION

1. Field of the Invention

The present invention generally relates to multiprocessor computer systems and, more specifically, to address translation and routing within a modular multiprocessor system having a plurality of multiprocessor building blocks interconnected by a switch fabric.

2. Background Information

A modular multiprocessor computer may comprise a plurality of multiprocessor building blocks that are interconnected by a switch fabric to form a system with high processor counts. Each multiprocessor building block or “node” is typically configured with a plurality of processors, memory and input/output (I/O) access hardware. In such a modular, switch-based configuration, it is desirable to allow flexible configuration and partitioning of the multiprocessor system.

Flexible configuration enables assignment of a specific address space or processor identifier (ID) range to any node regardless of its physical connection to the switch fabric. That is, flexible configuration allows system firmware to assign node address spaces and processor ID ranges based on attributes, such as processor count, memory capacity and the presence of I/O hardware within the node, instead of a specific physical connection to the switch fabric. This type of configuration feature obviates the need for onerous configuration restrictions, while further enabling the system to flexibly reconfigure in the event of a failure to a node with a specific physical connection to the switch fabric.

Flexible partitioning, on the other hand, allows “seamless” support for multiple operating system kernels executing in the multiprocessor system at the same time. To that end, each operating system must generally “see” an address space that begins with address location 0 and a processor ID set that begins with processor ID 0. This, in turn, requires that the system allow assignments of a similar address space to more than one node at the same time and a similar processor ID to more than one processor at the same time. Flexible partitioning further allows the multiprocessor system to be divided into hard partitions, wherein a hard partition is defined as an independent and complete address space and processor ID set. For example in a multiprocessor system having 6 nodes interconnected by a switch fabric, nodes 1 and 2 may be assigned a first address space, nodes 3 and 4 may be assigned a second address space, and nodes 5 and 6 may be assigned a third address space. These nodes may then be combined to form two hard partitions of three nodes, with one hard partition comprising nodes 1, 3 and 5, and the other hard partition comprising nodes 2, 4 and 6. Although both partitions of this example are the same size (e.g., three nodes), hard partitions may be different sizes.

Partitioning of a single computer system to enable simultaneous execution of multiple operating system kernels is generally uncommon. Typically, conventional computer systems allow multiple operating systems to operate together through the use of a clustering technique over, e.g., a computer network. In this implementation, clustering is defined as “macro” computer systems with multiple operating systems, each running on an independent constituent computer and interacting with other systems through the exchange of messages over the network in accordance with a network message passing protocol. Clustering techniques may also be applied to the individual partitions of a partitioned system.

In a shared memory multiprocessor system, the processors may share copies of the same piece (block) of data. Depending upon the cache coherency protocol used in the system, when a block of data is modified it is likely that any other copies of that data block have to be invalidated. In a modular multiprocessor system, this may further require that copies of an invalidate message be transmitted to more than one node. Ideally, these invalidate messages may be multicasted. In this context, the term multicast is defined as the transmission of a single message to a central point in the system where the message is transformed into multiple messages, each of which is transmitted to a unique target node. Multicast transmission can substantially reduce system bandwidth, particularly in a modular multiprocessor system having a plurality of nodes interconnected by a switch fabric.

Therefore, an object of the present invention is to provide an efficient means for flexible configuration and partitioning, as well as for message multicasting, in a modular, multiprocessor computer system.

### SUMMARY OF THE INVENTION

The present invention comprises a distributed address mapping and routing technique that supports flexible configuration and partitioning in a modular, shared memory multiprocessor system having a plurality of multiprocessor building blocks interconnected by a switch fabric. The novel technique generally employs physical-to-logical address translation mapping in conjunction with source routing. Mapping operations, such as address range or processor identifier (ID) lookup operations, used to determine a routing path through the switch fabric for a message issued by a source multiprocessor building block are resolved through the generation of a routing word. That is, each message transmitted by a source multiprocessor building block over the switch fabric has an appended routing word that specifies the routing path of the message through the fabric.

According to an aspect of the present invention, the routing word contains only information pertaining to forwarding of the message through a specified physical connection in the switch fabric. Address range and processor ID information are not needed to route the message. To that end, the routing word preferably comprises a vector of bits, wherein a location of each bit corresponds to a physical connection to the switch fabric. Thus, an asserted bit of the routing word instructs the switch fabric to forward the message over the physical connection corresponding to the location of the asserted bit within the vector. If multiple bits in the vector are asserted, the message is multicasted or transformed into multiple messages, each of which is forwarded over a physical connection corresponding to an asserted bit location.

Each source multiprocessor building block derives the routing word from a routing table having an entry for each physical connection to the switch fabric. Each entry maps a specific address range and processor ID range to a corresponding connection in the switch fabric. Firmware/software may program specific address and processor ID ranges to correspond to specific physical connections. The address of a message that references a specific memory or input/output (I/O) space address is compared with the address ranges in the routing table to determine at which physical connection of the switch fabric the desired data can be located. Similarly, the multiple processor or building block IDs that may be associated with the message, such as a source processor ID or a sharing processor ID for an invalidate command, are compared with the processor or building block ID ranges in the routing table to determine at which physical connection the referenced processor can be found. In each case, the message is transmitted to the switch fabric accompanied by an appended routing word having one or more asserted bits denoting the determined connections through the switch fabric.

In the illustrative embodiment, the multiprocessor building blocks are preferably nodes interconnected by a switch fabric, such as a hierarchical switch. Each node comprises address mapping and routing logic that includes a routing table. The hierarchical switch is preferably implemented as an 8-port crossbar switch and, accordingly, the routing word derived from the routing table preferably comprises an 8-bit vector. Each address range is implemented such that a starting address of the range is determined by high-order bits of an address. Although this may cause “holes” in the complete memory space, this type of implementation also allows use of a single field in the routing table for address and processor or node range checking.

The nodes of the multiprocessor system may be configured as a single address space or a plurality of independent address spaces, each associated with a hard partition of the system. In a system having a single address space, each routing table is programmed such that a specific address or processor ID range may be assigned to at most one node or processor, which may have one physical connection to the switch fabric. However, in a system having a plurality of hard partitions, disparate routing tables are utilized and a specific address or processor ID range may be assigned to one node or processor or to multiple nodes or processors, which may have common or disparate physical connections to the switch fabric. Here, if ranges are assigned to one node or processor, the nodes associated with the routing tables are included in a common hard partition. On the other hand, if ranges are assigned to multiple nodes or processors, the nodes associated with the routing tables are included in disparate partitions. In any case, all routing tables are programmed such that all hard partitions are mutually exclusive.

Advantageously, the distributed address mapping and routing technique allows multiple copies of an operating system, or a variety of different operating systems, to run within the same multiprocessor system at the same time. The novel technique includes a “fail-over” feature that provides flexibility when configuring the system during a power-up sequence in response to a failure in the system. The flexible fail-over configuration aspect of the technique conforms to certain system requirements, such as providing a processor ID 0 and a memory address location 0 in the system. In addition, the inventive address mapping and routing technique conforms to hardware-supported hard partitions within a cache coherent multiprocessor system, wherein each hard partition includes a processor ID 0 and a memory address location 0. The invention also supports multicasting of messages, thereby substantially reducing system bandwidth.

### BRIEF DESCRIPTION OF THE DRAWINGS

The above and further advantages of the invention may be better understood by referring to the following description in conjunction with the accompanying drawings, in which like reference numbers indicate identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node, including a directory (DIR) and mapping logic, coupled to the SMP system of FIG. 1;

FIG. 3 is a schematic block diagram of the organization of the DIR;

FIG. 4 is a schematic block diagram of the HS of FIG. 1;

FIG. 5 is a schematic block diagram of a novel routing table contained within the mapping logic of a QBB node;

FIG. 6 is a highly schematized diagram illustrating a SMP system embodiment wherein the QBB nodes collectively form one monolithic address space that may be advantageously used with a distributed address mapping and routing technique of the present invention; and

FIG. 7 is a highly schematized diagram illustrating another SMP system embodiment wherein the QBB nodes are partitioned into a plurality of hard partitions that may be advantageously used with the distributed address mapping and routing technique of the present invention.

### DETAILED DESCRIPTION OF AN ILLUSTRATIVE EMBODIMENT

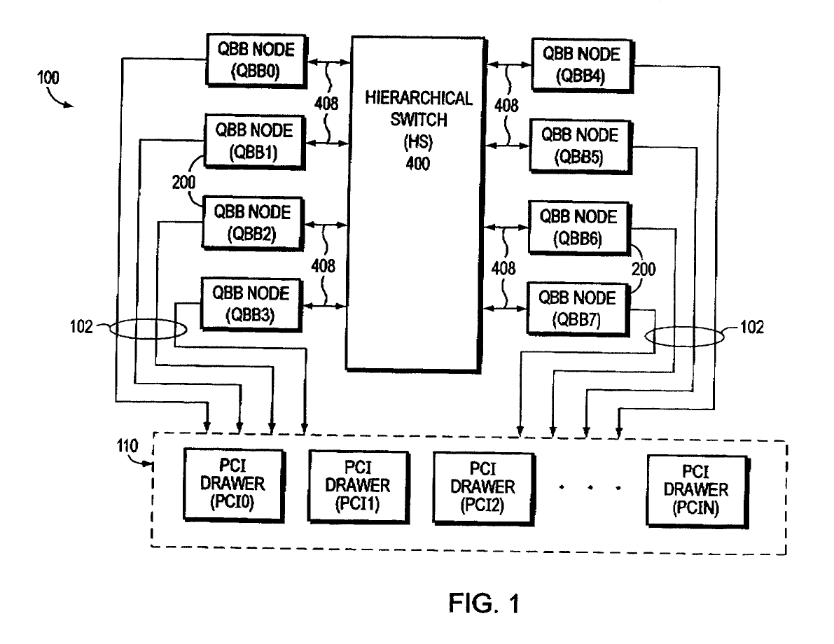

FIG. 1 is a schematic block diagram of a modular, symmetric multiprocessing (SMP) system 100 having a plurality of nodes interconnected by a hierarchical switch (HS) 400. The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising a plurality of processors, a plurality of memory modules, an I/O port (IOP) and a global port (GP) interconnected by a local switch. Each memory module may be shared among the processors of a node and, further, among the processors of other QBB nodes configured on the SMP system. A fully configured SMP system preferably comprises eight (8) QBB (QBB0-7) nodes, each of which is coupled to the HS 400 by a full-duplex, bidirectional, clock forwarded HS link 408.

Data is transferred between the QBB nodes of the system in the form of packets. In order to provide a distributed shared memory environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

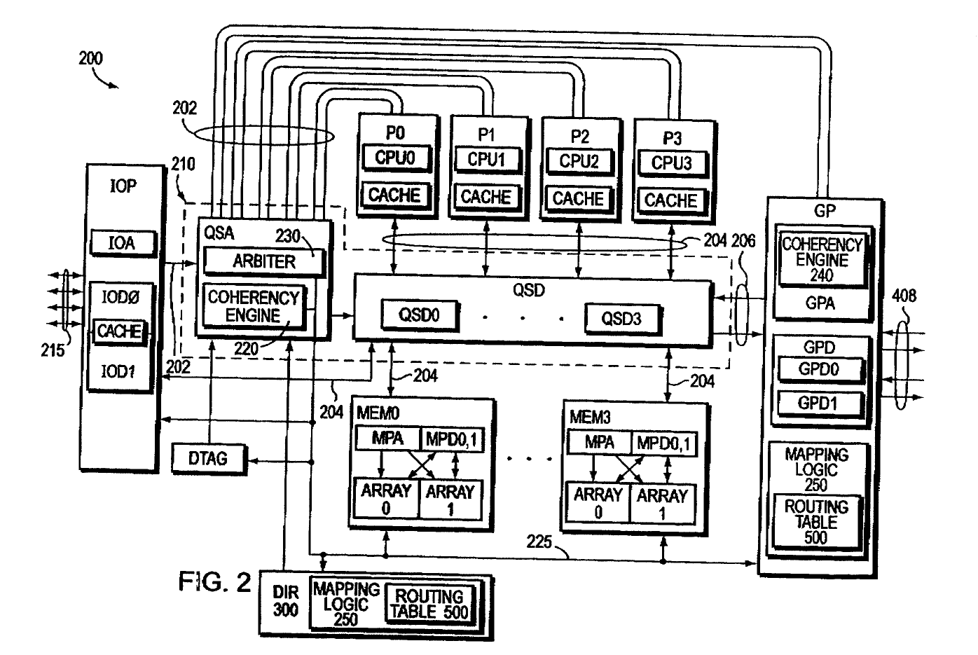

FIG. 2 is a schematic block diagram of a QBB node 200 comprising a plurality of processors (P0-P3) coupled to the IOP, the GP and a plurality of memory modules (MEMO-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/0 hoses 102. As with the case of the SMP system, data is transferred among the components or “agents” of the QBB node in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, although other types of processor chips may be advantageously used. The load/store instructions executed by the processors are issued to the system as memory references, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches.

Unlike a computer network environment, the SMP system 100 is bounded in the sense that the processor and memory agents are interconnected by the HS 400 to provide a tightly-coupled, distributed shared memory, cache-coherent SMP system. In a typical network, cache blocks are not coherently maintained between source and destination processors. Yet, the data blocks residing in the cache of each processor of the SMP system are coherently maintained. Furthermore, the SMP system may be configured as a single cache-coherent address space or it may be partitioned into a plurality of hard partitions, wherein each hard partition is configured as a single, cache-coherent address space.

Moreover, routing of packets in the distributed, shared memory cache-coherent SMP system is performed across the HS 400 based on address spaces of the nodes in the system. That is, the memory address space of the SMP system 100 is divided among the memories of all QBB nodes 200 coupled to the HS. Accordingly, a mapping relation exists between an address location and a memory of a QBB node that enables proper routing of a packet over the HS 400. For example, assume a processor of QBB0 issues a memory reference command packet to an address located in the memory of another QBB node. Prior to issuing the packet, the processor determines which QBB node has the requested address location in its memory address space so that the reference can be properly routed over the HS. As described herein, mapping logic is provided within the GP and directory of each QBB node that provides the necessary mapping relation needed to ensure proper routing over the HS 400.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. Specifically, the IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS via a set of unidirectional, clock forwarded address and data HS links 408.

A plurality of shared data structures are provided for capturing and maintaining status information corresponding to the states of data used by the nodes of the system. One of these structures is configured as a duplicate tag store (DTAG) that cooperates with the individual caches of the system to define the coherence protocol states of data in the QBB node. The other structure is configured as a directory (DIR) 300 to administer the distributed shared memory environment including the other QBB nodes in the system. The protocol states of the DTAG and DIR are further managed by a coherency engine 220 of the QSA that interacts with these structures to maintain coherency of cache lines in the SMP system.

Although the DTAG and DIR store data for the entire system coherence protocol, the DTAG captures the state for the QBB node coherence protocol, while the DIR captures a coarse protocol state for the SMP system protocol. That is, the DTAG functions as a “short-cut” mechanism for commands (such as probes) at a “home” QBB node, while also operating as a refinement mechanism for the coarse state stored in the DIR at “target” nodes in the system. Each of these structures interfaces with the GP to provide coherent communication between the QBB nodes coupled to the HS.

The DTAG, DIR, coherency engine, IOP, GP and memory modules are interconnected by a logical bus, hereinafter referred to as an Arb bus 225. Memory and I/O reference operations issued by the processors are routed by an arbiter 230 of the QSA over the Arb bus 225. The coherency engine and arbiter are preferably implemented as a plurality of hardware registers and combinational logic configured to produce sequential logic circuits and cooperating state machines. It should be noted, however, that other configurations of the coherency engine, arbiter and shared data structures may be advantageously used herein.

Specifically, the DTAG is a coherency store comprising a plurality of entries, each of which stores a cache block state of a corresponding entry of a cache associated with each processor of the QBB node. Whereas the DTAG maintains data coherency based on states of cache blocks located on processors of the system, the DIR 300 maintains coherency based on the states of memory blocks located in the main memory of the system. Thus, for each block of data in memory, there is a corresponding entry (or “directory word”) in the DIR that indicates the coherency status/state of that memory block in the system (e.g., where the memory block is located and the state of that memory block).

Cache coherency is a mechanism used to determine the location of a most current, up-to-date copy of a data item within the SMP system. Common cache coherency policies include a “snoop-based” policy and a directory-based cache coherency policy. A snoop-based policy typically utilizes a data structure, such as the DTAG, for comparing a reference issued over the Arb bus with every entry of a cache associated with each processor in the system. A directory-based coherency system, however, utilizes a data structure such as the DIR 300.

Since the DIR 300 comprises a directory word associated with each block of data in the memory, a disadvantage of the directory-based policy is that the size of the directory increases with the size of the memory. In the illustrative embodiment described herein, the modular SMP system has a total memory capacity of 256 GB of memory; this translates to each QBB node having a maximum memory capacity of 32 GB. For such a system, the DIR requires 500 million entries to accommodate the memory associated with each QBB node. Yet the cache associated with each processor comprises 4 MB of cache memory which translates to 64K cache entries per processor or 256K entries per QBB node.

Thus, it is apparent from a storage perspective that a DTAG-based coherency policy is more efficient than a DIR-based policy. However, the snooping foundation of the DTAG policy is not efficiently implemented in a modular system having a plurality of QBB nodes interconnected by an HS. Therefore, in the illustrative embodiment described herein, the cache coherency policy preferably assumes an abbreviated DIR approach that employs distributed DTAGs as short-cut and refinement mechanisms

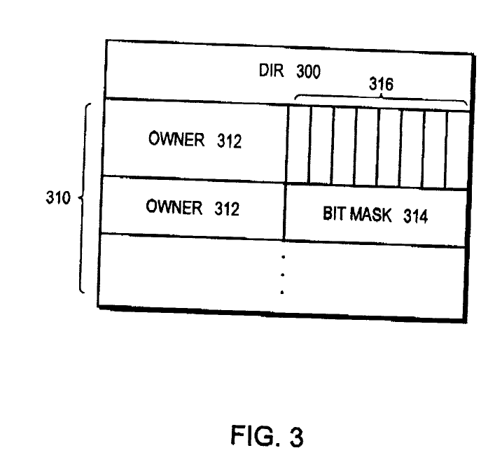

FIG. 3 is a schematic block diagram of the organization of the DIR 300 having a plurality of entries 310, each including an owner field 312 and a bit-mask field 314. The owner field 312 identifies the agent (e.g., processor, IOP or memory) having the most current version of a data item in the SMP system, while the bit-mask field 314 has a plurality of bits 316, each corresponding to a QBB of the system. When asserted, the bit 316 indicates that its corresponding QBB has a copy of the data item. Each time a 64-byte block of data is retrieved from the memory, the DIR provides a directory word (i.e., the directory entry 310 corresponding to the address of the data block) to the coherency engine 220. The location of the data block in memory and the location of the directory entry 310 in the directory are indexed by the address of the request issued over the Arb bus 225 in accordance with a fill, direct address look-up operation.

For example, if a processor issues a write request over the Arb bus 225 to overwrite a particular data item, a look-up operation is performed in the DIR based on the address of the request. The appropriate directory entry 310 in the DIR may indicate that certain QBB nodes have copies of the data item. The directory entry/word is provided to a coherency engine 240 of the GPA, which generates a probe command (e.g., an invalidate probe) to invalidate the data item. The probe is replicated and forwarded to each QBB having a copy of the data item. When the invalidate probe arrives at the Arb bus associated with each QBB node, it is forwarded to the DTAG where a subsequent look-up operation is performed with respect to the address of the probe. The look-up operation is performed to determine which processors of the QBB node should receive a copy of the invalidate probe.

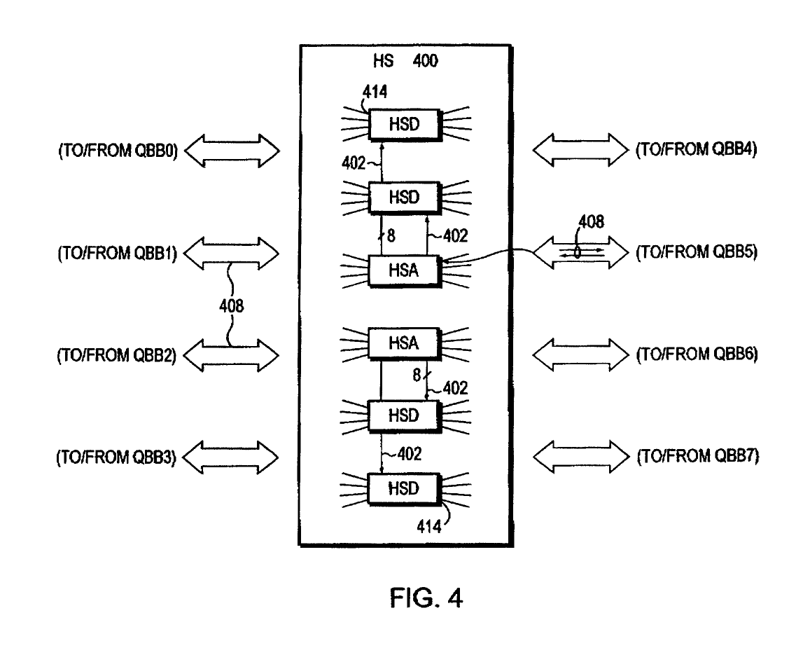

FIG. 4 is a schematic block diagram of the HS 400 comprising a plurality of HS address (HSA) ASICs and HS data (HSD) ASICs. In the illustrative embodiment, each HSA controls two (2) HSDs in accordance with a master/slave relationship by issuing commands over lines 402 that instruct the HSDs to perform certain functions. Each HSA and HSD includes eight (8) ports 414, each accommodating a pair of unidirectional interconnects; collectively, these interconnects comprise the HS links 408. There are sixteen command/address paths in/out of each HSA, along with sixteen data paths in/out of each HSD. However, there are only sixteen data paths in/out of the entire HS; therefore, each HSD preferably provides a bit-sliced portion of that entire data path and the HSDs operate in unison to transmit/receive data through the switch. To that end, the lines 402 transport eight (8) sets of command pairs, wherein each set comprises a command directed to four (4) output operations from the HS and a command directed to four (4) input operations to the HS.

The present invention comprises a distributed address mapping and routing technique that supports flexible configuration and partitioning in a modular, shared memory multiprocessor system, such as SMP system 100. That is, the SMP system may be a partitioned system that can be divided into multiple hard partitions, each possessing resources such as processors, memory and I/O agents organized as an address space having an instance of an operating system kernel loaded thereon. To that end, each hard partition in the SMP system requires a memory address location 0 so that the loaded instance of the operating system has an available address space that begins at physical memory address location 0.

Furthermore, each instance of an operating system executing in the partitioned SMP system requires that its processors be identified starting at processor identifier (ID) 0 and continuing sequentially for each processor in the hard partition. Thus, each partition requires a processor ID 0 and a memory address location 0. For this reason, a processor “name” includes a logical QBB ID label and the inventive address mapping technique described herein uses the logical ID for translating a starting memory address (e.g., memory address 0) to a physical memory location in the SMP system (or in a hard partition).

The inventive technique generally relates to routing of messages (i.e., packets) among QBB nodes 200 over the HS 400. Each node comprises address mapping and routing logic (“mapping logic” 250) that includes a routing table 500. Broadly stated, a source processor of a QBB node issues a memory reference packet that includes address, command and identification information to the mapping logic 250, which provides a routing mask that is appended to the original packet. The identification information is, e.g., a processor ID that identifies the source processor issuing the memory reference packet. The processor ID includes a logical QBB label (as opposed to a physical label) that allows use of multiple similar processor IDs (such as processor ID 0) in the SMP system, particularly in the case of a partitioned SMP system. The mapping logic 250 essentially translates the address information contained in the packet to a routing mask that provides instructions to the HS 400 for routing the packet through the SMP system.

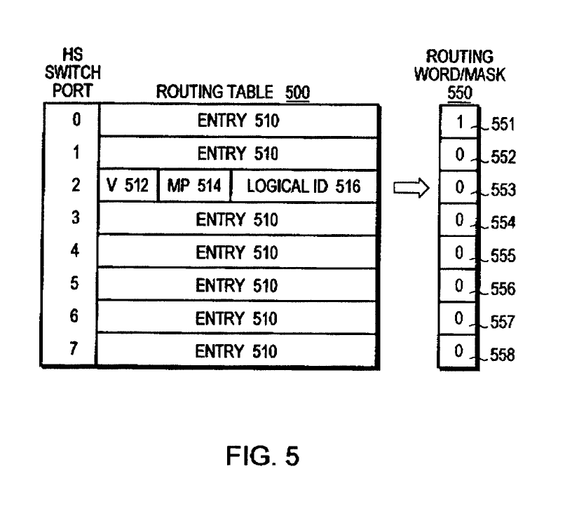

FIG. 5 is a schematic block diagram of the routing table 500 contained within the mapping logic 250 of a QBB node. The routing table 500 preferably comprises eight (8) entries 510, one for each physical switch port of the HS 400 coupled to a QBB node 200. Each entry 510 comprises a valid (V) bit 512 indicating whether a QBB node is connected to the physical switch port, a memory present (MP) bit 514 indicating whether memory is present and operable in the connected QBB node, and a memory space number or logical ID 516. As described herein, the logical ID represents the starting memory address of each QBB node 200.

In the illustrative embodiment, the address space of the SMP system extends from, e.g., address location 0 to address location 7F.FFFF.FFFF. The address space is divided into 8 memory segments, one for each QBB node. Each segment is identified by the upper three most significant bits (MSB) of an address. For example, the starting address of segment 0 associated with QBB0 is 00.0000.0000, whereas the starting address of segment 1 associated with QBB1 is 10.0000.0000. Each memory segment represents the potential memory storage capacity available in each QBB node. However, each QBB node may not utilize its entire memory address space.

For example, the memory address space of a QBB node is 64 gigabytes (GB), but each node preferably supports only 32 GB. Thus, there may be “holes” within the memory space segment assigned to each QBB. Nevertheless, the memory address space for the SMP system (or for each hard partition in the SMP system) preferably begins at memory address location 0. The logical ID 516 represents the MSBs (e.g., bits 38-36) of addresses used in the SMP system. That is, these MSBs are mapped to the starting address of each QBB node segment in the SMP system.

Assume each entry 510 of each routing table 500 in the SMP system 100 has its V and MP bits asserted, and each QBB node coupled to the HS 400 is completely configured with respect to, e.g., its memory. Therefore, the logical ID 516 assigned to each entry 510 is equal to the starting physical address of each memory segment of each QBB node 200 in the SMP system. That is, the logical ID for entry 0 is “000”, the logical ID for entry one is “001” and the logical ID for entry number 2 is “010”. Assume further that a processor issues a memory reference packet to a destination address location 0 and that the packet is received by the mapping logic 250 on its QBB node. The mapping logic performs a lookup operation into its routing table 500 and compares physical address location 0 with the logical ID 516 of each entry 510 in the table.

According to the present invention, the comparison operation results in physical address location 0 being mapped to physical QBB0 (i.e., entry 0 of the routing table). The mapping logic 250 then generates a routing word (mask) 550 that indicates this mapping relation by asserting bit 551 of the word 550 and appends that word to the memory reference packet. The packet and appended routing word 550 are forwarded to the HS 400, which examines the routing word. Specifically, the assertion of bit 551 of the routing word instructs the HS to forward the memory reference packet to physical switch port 0 coupled to physical QBB0. Translation mapping may thus comprise a series of operations including, e.g., (i) a lookup into the routing table, (ii) a comparison of the physical address with each logical ID in each entry of the table and, upon realizing a match, (iii) assertion of a bit within a routing word that corresponds to the physical port of the HS matching the logical ID of the destination QBB node.

Specifically, the mapping logic 250 compares address bits <38-36> of the memory reference packet with each logical ID 516 in each entry 510 of the routing table 500. For each logical ID that matches the address bits of the packet, a bit is asserted in the routing word that corresponds to a physical switch port in the HS. The routing word is then appended to the memory reference packet and forwarded to the HS 400. The HS examines the routing word and, based on the asserted bits within the word, renders a forwarding decision for the memory reference packet. Thus, in terms of forwarding through the switch, the HS treats the packet as “payload” attached to the routing word. Ordering rules within the SMP system are applied to the forwarding decision rendered by the HS. If multiple bits are asserted within the routing word, the HS replicates the packet and forwards the replicated copies of the packet to the switch ports corresponding to the asserted bits.

In the illustrative embodiment, the contents of the bit-mask field 314 of a directory entry 310 are preferably a mask of bits representing the logical system nodes. As a result, the contents of the bit-mask 314 must be combined with the mapping information in routing table 500 to formulate a multicast routing word. Specifically, combinatorial logic in the GP of each QBB node decodes each bit of the mask into a 3-bit logical node number. All of the eight possible logical node numbers are then compared in parallel with all eight of the entries in routing table 500. For each entry in the table for which there is a match, a bit is set in the resultant routing word.

The SMP system 100 includes a console serial bus (CSB) subsystem that manages various power, cooling and clocking sequences of the nodes within the SMP system. In particular, the CSB subsystem is responsible for managing the configuration and power-up sequence of agents within each QBB node, including the HS, along with conveying relevant status and inventory information about the agents to designated processors of the SMP system. The CSB subsystem includes a plurality of microcontrollers, such as a plurality of “slave” power system module (PSM) microcontroller, each resident in a QBB node, and a “master” system control module (SCM) microcontroller.

During phases of the power-up sequence, the PSM in each QBB node 200 collects presence (configuration) information and test result (status) information of executed SROM diagnostic code pertaining to the agents of the node, and provides that information to the SCM. This enables the SCM to determine which QBB nodes are present in the system, which processors of the QBB nodes are operable and which QBB nodes have operable memory in their configurations. Upon completion of the SROM code, processor firmware executes an extended SROM code. At this time, the firmware also populates/programs the entries 510 of the routing table 500 using the presence and status information provided by the SCM.

More specifically, a primary processor election procedure is performed for the SMP system (or for each hard partition in the SMP system) and, thereafter, the SCM provides the configuration and status information to the elected primary processor. Thus, in a partitioned system, there are multiple primary or master processors. The console firmware executing on the elected primary processor uses the information to program the routing table 500 located in the GP (and DIR) on each QBB node (of each partition) during, e.g., phase 1 of the power-up sequence. The elected processor preferably programs the routing table in accordance with programmed I/O or control status register (CSR) write operations. Examples of primary processor election procedures that may be advantageously used with the present invention are described in copending U.S. patent application Ser. Nos. 09/546,340, filed Apr. 7, 2000 titled, Adaptive Primary Processor Election Technique in a Distributed, Modular, Shared Memory, Multiprocessor System and 09/545,535, filed Apr. 7, 2000 titled, Method and Apparatus for Adaptive Per Partition Primary Processor Election in a Distributed Multiprocessor System, which applications are hereby incorporated by reference as though fully set forth herein.

The novel address mapping and routing technique includes a “fail-over” feature that provides flexibility when configuring the system during a power-up sequence in response to a failure in the system. Here, the flexible fail-over configuration aspect of the technique conforms to certain system requirements, such as providing a processor ID 0 and a memory address location 0 in the system. For example, assume that QBB0 fails as a result of testing performed during the phases of the power-up sequence. Thereafter, during phase 1 of the power-up sequence the primary processor configures the routing table 500 based on the configuration and status information provided by the SCM. However, it is desirable to have a memory address location 0 within the SMP system (or hard partition) even though QBB0 is non-functional.

According to the inventive technique, the console firmware executing on the primary processor may assign logical address location 0 to physical switch port 1 coupled to QBB1 of the SMP system. Thereafter, when a memory reference operation is issued to memory address location 0, the mapping logic 250 performs a lookup operation into the routing table 500 and translates memory address 0 to physical switch port 1 coupled to QBB 1. That is, the address mapping portion of the technique translates physical address location 0 to a logical address location 0 that is found in physical QBB1 node. Moreover, logical QBB0 may be assigned to physical QBB 1. In this manner, any logical QBB ID can be assigned to any physical QBB ID (physical switch port number) in the SMP system using the novel translation technique.

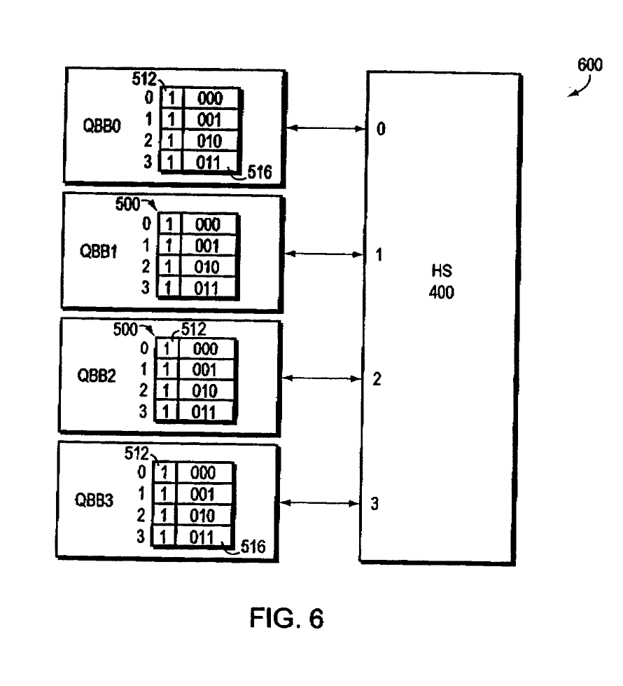

FIG. 6 is a highly schematized diagram illustrating a SMP system embodiment 600 wherein the QBB nodes collectively form one monolithic address space that may be advantageously used with the distributed address mapping and routing technique of the present invention. As noted, the routing table 500 has an entry for each QBB node coupled to the HS 400 and, in this embodiment, there are preferably four (4) QBB nodes coupled to the HS. Since each QBB node is present and coupled to the HS, the V bits 512 are asserted for all entries in each routing table 500 and the logical IDs 516 within each routing table extend from logical ID 0 to logical ID 3 for each respective QBB0-3. In addition, each QBB node can “see” the memory address space of the other QBB nodes coupled to the HS and the logical ID assignments are consistent across the routing table on each QBB node. Therefore, each node is instructed that logical memory address location 0 is present in physical QBB node 0 and logical memory address location 1 (i.e., the memory space whose address bits <38-36>=001) is present in physical QBB node 1. Similarly, processor ID 0 is located on physical QBB node 0 and processor ID 12 is located on physical QBB node 3.

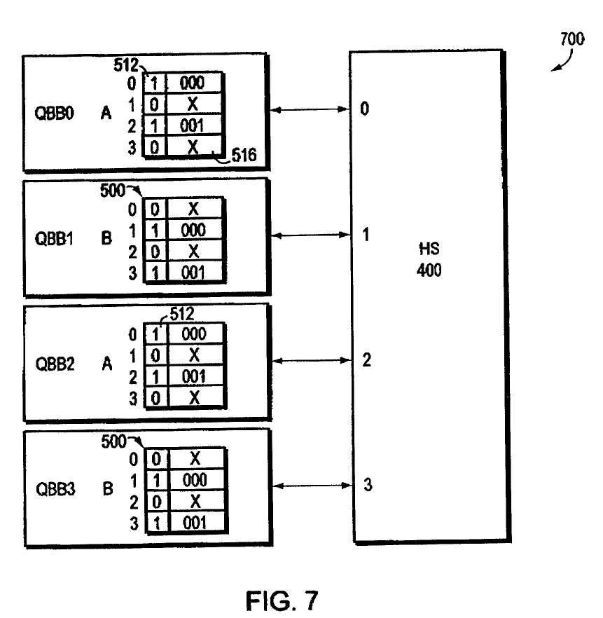

FIG. 7 is a highly schematized diagram illustrating another SMP system embodiment 700 wherein the QBB nodes are partitioned into a plurality of hard partitions that may be advantageously used with the distributed address mapping and routing technique of the present invention. Hard partition A comprises QBB nodes 0 and 2, while hard partition B comprises QBB nodes 1 and 3. For each hard partition, there is a memory address location 0 (and an associated logical ID 0). The logical processor naming (i.e., logical QBB ID) convention further provides for a processor ID 0 associated with each hard partition.

Specifically, QBB0 connected to physical switch port 0 can only “see” memory address space segments beginning at memory address locations 0 and 1 associated with QBB0 and QBB2 because the V bits 512 in its routing table 500 are only asserted for those QBB nodes. Note that the letter “X” denotes a “don't care” state in the routing table. Similarly, QBB1 connected to physical port number 1 of the HS 400 can only see the memory address segments starting at memory addresses 0 and 1 associated with QBB 1 and QBB3 because the V bits 512 in its routing table are only asserted for those QBB nodes. Thus, the novel technique essentially isolates QBB nodes 0 and 2 from QBB nodes 1 and 3, thereby enabling partitioning of the SMP system into two independent cache-coherent domains A and B, each associated with a hard partition.

As noted, the routing word appended to a memory reference packet is configured based on the assertion of V bits within the routing table of each QBB node. Assertion of V bits 512 within entries 510 of the routing table 500 on each QBB node denotes members belonging to each hard partition. As a result, a processor of a node within hard partition A cannot access a memory location on hard partition B even though those nodes are connected to the HS. The HS examines that routing word to determine through which physical port the packet should be forwarded. The routing word derived from a routing table of a node within hard partition A has no V bits asserted that correspond to a QBB node on hard partition B. Accordingly, the processor on hard partition A cannot access any memory location on hard partition B. This aspect of the invention provides hardware support for partitioning in the SMP system, resulting in a significant security feature of the system.

According to a flexible configuration feature of the present invention, the address mapping and routing technique supports failover in the SMP system. That is, the novel technique allows any physical QBB node to be logical QBB0 either during primary processor election, as a result of a failure and reboot of the system, or as a result of “hot swap”, the latter enabling reassignment of QBB0 based on firmware control. In the illustrative embodiment, there are a number of rules defining what constitutes QBB0 in the SMP system including a QBB node having a functional processor, a standard I/O module with an associated SCM microcontroller and a SRM console, and functional memory. These rules also are used for primary processor election and the resulting elected primary processor generally resides within QBB0.

While the address mapping and routing technique is illustratively described with respect to memory space addresses, it is to be understood that various other adaptations and modifications may be made within the spirit and scope of the invention. For example, the inventive technique applies equally to I/O address space references in the SMP system. For example, a processor that issues a write operation to a CSR on another QBB node may use the address mapping technique described herein with the logical IDs of the memory space being inverted. That is, the memory space addresses generally increase from logical QBB0 to logical QBB7, whereas the I/O space addresses generally decrease from logical QBB0 to QBB7. Thus, the novel address mapping and routing technique described herein can also be used for I/O and CSR references in the SMP system.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for implementing hard partitions and high availability in a modular, shared memory multiprocessor system defining an address space and having a plurality of multiprocessor nodes interconnected by a switch fabric, the nodes configured to generate and exchange messages, the method comprising the steps of:
providing each processor of a node with a processor identifier (ID);
partitioning the multiprocessor system into a plurality of hard partitions, each hard partition including at least one multiprocessor node;
mapping the system address space so as to provide a physical address of zero within each hard partition;
mapping the processor IDs so as to provide a single processor with a processor ID of zero within each hard partition; and
blocking messages originating in a first hard partition from entering a second hard partition.

2. The method of claim 1 wherein
each node includes an address mapping and routing table having a plurality of entries, and
each routing table entry is associated with a node of the system and includes a valid bit, an address space number field and a processor space number field.

3. The method of claim 2 wherein the step of mapping address space comprises the steps of:
assigning a unique address value to the physical address of a first node;
writing the unique address value into the address space number field of the routing table entry corresponding to the first node; and
asserting the valid bit of the respective routing table entry.

4. The method of claim 3 wherein the address mapping and routing tables are configured such that any value may be entered into the address space number fields of the routing table entries associated with any node.

5. The method of claim 4 wherein the step of mapping processor IDs comprises the steps of:
assigning a unique ID value as a processor ID for a processor of a second node;
writing the unique ID value into the processor space number field of the routing table entry corresponding to the second node; and
asserting the valid bit of the respective routing table entry.

6. The method of claim 5 wherein the address mapping and routing tables are configured such that any value may be entered into the processor space number fields of the routing table entries associated with any node.

7. The method of claim 6 wherein the step of mapping address space further comprises the steps of:
within each routing table, writing the unique address value into the address space number field of the routing table entry corresponding to the first node; and
within each routing table, writing the unique ID value into the processor space number field of the routing table entry corresponding to the second node.

8. The method of claim 7 wherein the first and second nodes are the same node.

9. The method of claim 7 wherein the step of blocking comprises the steps of:
within the routing tables disposed within a given hard partition, asserting the respective valid bits of the routing table entries that correspond to the nodes that are part of the given hard partition;
deasserting the valid bits of the routing table entries that correspond to the nodes that are not part of the given hard partition;
within the given hard partition, programming the valid routing table entries to contain the same information; and
routing messages originating within the given hard partition only to nodes whose corresponding routing table entries are valid.

10. The method of claim 9 wherein the step of blocking further comprises the step of preventing messages originating within the given hard partition from being routed to a node whose corresponding routing table entry is invalid.

11. The method of claim 10 wherein, for each hard partition, the routing table entries corresponding to a selected node that is part of the respective hard partition are programmed such that the selected node is mapped to address space zero and the respective routing table entries are valid.

12. The method of claim 11 wherein, for each hard partition, the routing table entries corresponding to a selected node that is part of the respective hard partition are programmed such that a processor of the selected node is assigned processor ID zero and the respective routing table entries are valid.

13. The method of claim 1 wherein
each node includes an address mapping and routing table having a plurality of entries,
each routing table entry is associated with a node of the system and includes a valid bit and a logical node field, and
the logical node field maps both an address space and a processor ID space for the respective node.

14. The method of claim 13 wherein the step of mapping address space comprises the steps of:
assigning a unique address value to the physical address of a first node;
writing the unique address value into the logical node field of the routing table entry corresponding to the first node; and
asserting the valid bit of the respective routing table entry.

15. The method of claim 14 wherein the step of mapping processor IDs comprises the steps of:
assigning a unique ID value as a processor ID for a processor of a second node;
writing the unique ID value into the logical node field of the routing table entry corresponding to the second node; and
asserting the valid bit of the respective routing table entry.

16. The method of claim 15 wherein the step of mapping address space further comprises the steps of:
within each routing table, writing the unique address value into the logical node field of the routing table entry corresponding to the first node; and
within each routing table, writing the unique ID value into the logical node field of the routing table entry corresponding to the second node.

17. The method of claim 16 wherein the first and second nodes are the same node.

18. The method of claim 16 wherein the step of blocking comprises the steps of:
within the routing tables disposed within a given hard partition, asserting the respective valid bits of the routing table entries that correspond to the nodes that are part of the given hard partition;
deasserting the valid bits of the routing table entries that correspond to the nodes that are not part of the given hard partition;
within the given hard partition, programming the valid routing table entries to contain the same information; and
routing messages originating within the given hard partition only to nodes whose corresponding routing table entries are valid.

19. The method of claim 18 wherein the step of blocking further comprises the step of preventing messages originating within the given hard partition from being routed to a node whose corresponding routing table entry is invalid.

20. The method of claim 19 wherein, for each hard partition, the routing table entries corresponding to a selected node that is part of the respective hard partition are programmed such that the selected node is mapped to address space zero and the respective routing table entries are valid.

21. The method of claim 20 wherein, for each hard partition, the routing table entries corresponding to a selected node that is part of the respective hard partition are programmed such that a processor of the selected node is assigned processor ID zero and the respective routing table entries are valid.

22. A modular, shared memory multiprocessor system comprising:
a switch fabric;
a plurality of multiprocessor building blocks interconnected by the switch fabric and configured to generate and send messages across the switch fabric, one or more of the multiprocessor building blocks including a memory system having a starting memory address; and
mapping logic disposed at each multiprocessor building block, wherein
at least some of the messages carry an address of a destination multiprocessor building block, and
the mapping logic is configured to (1) generate a routing word for the messages in response to a translation mapping operation performed on the destination address of the message, the routing word specifying a routing path of the message through the switch fabric, and (2) append the routing the word to the message.

23. The modular, shared memory multiprocessor system of claim 22 wherein,
each multiprocessor building block has at least one connection to the switch fabric,
the mapping logic at each multiprocessor building block includes a routing table
each routing table has a plurality of entries,
each routing table entry is associated with the connection of a respective multiprocessor building block to the switch fabric.

24. The modular, shared memory multiprocessor system of claim 23 wherein each routing table entries includes
a valid bit, and
a logical identifier (ID) that includes (1) an address range for the memory addresses of the respective multiprocessor building block, and (2) a processor ID range for the processors of the respective multiprocessor building block.

25. The modular, shared memory multiprocessor system of claim 24 wherein the routing word is a bit vector having a bit for each routing table entry, and the mapping logic compares the destination address of a given message to the logical ID of each routing table entry and, if the destination address matches the respective address range or processor ID range, the mapping logic asserts the bit of the bit vector that is associated with the matching routing table entry.

26. The modular, shared memory multiprocessor system of claim 25 wherein,
the system has two or more hard partitions,
each hard partition includes at least one multiprocessor building block, and
the logical IDs and valid bits of the routing table entries are configured such that, for each hard partition, a given multiprocessor building block has a starting memory address of “0”.

27. The modular, shared memory multiprocessor system of claim 26 wherein the logical IDs and valid bits of the routing table entries are further configured such that, for each hard partition, a given processor has an ID of “0”.

28. The modular, shared memory multiprocessor system of claim 27 wherein the multiprocessor building blocks are nodes and the switch fabric is a hierarchical switch.
